(19) United States
(12) Patent Application Publication
(10) Pub. No.: US 2026/0235297 A1
(43) Pub. Date: Aug. 13, 2026

(54) COOKING APPARATUS

(71) Applicant: LG ELECTRONICS INC., Seoul (KR)

(72) Inventors: Keunho Ju, Seoul (KR); Sanghun Kim, Seoul (KR); Byeongkook Kim, Seoul (KR); Suhyeon Son, Seoul (KR)

(73) Assignee: LG ELECTRONICS INC., Seoul (KR)

(21) Appl. No.: 19/533,973

(22) Filed: Feb. 9, 2026

(30) Foreign Application Priority Data
Feb. 10, 2025 (KR) 10-2025-0016773

(51) Int. Cl. F24C 15/02; E05D 11/00

(52) U.S. Cl. CPC F24C 15/023; E05D 11/0054; E05Y 2201/11; E05Y 2900/308

(57) ABSTRACT

A cooking appliance of the present disclosure includes a cavity which forms a cooking chamber therein; a casing which encloses at least a portion of the cavity; a door which is hinged to the casing by a hinge rotation connector to open and close the cavity; and a concealing cover which is withdrawn from a space between the cavity and the casing, and conceals the hinge rotation connector, when the door is opened.

### TECHNICAL FIELD

This disclosure relates to a cooking appliance, and more particularly, to a cooking appliance that can be linked to the opening and closing of an oven door while concealing a hinge and a harness portion.

### BACKGROUND

A variety of cooking appliances, such as a microwave oven utilizing microwaves, a heater-based oven, and a cooktop, are becoming widespread.

A microwave oven irradiates microwaves generated by a magnetron into a sealed cooking chamber, and vibrates water molecules in a food received in the cooking chamber to heat food, and oven heats the food received in the cooking chamber by heating the sealed cooking chamber using a heater.

Furthermore, cooking appliances are diversifying in functionality, and cooking appliances that perform functions conventionally performed separately by two or more cooking appliances are being developed in a single device.

These cooking appliances may have a casing that can be built into a home, or may be sold as a separate product for installation in a location desired by a user within a home.

FIG. 1 is a perspective view of an example of a conventional cooking appliance, and FIG. 2 is a front view of FIG. 1.

A conventional cooking device 1 includes a casing 10 having a cavity 101 for cooking food. A door 20 may be provided on the front end of the casing 10 to open and close the cavity 101 via a lower hinge rotation connector 30. The door 20 has a lower portion connected to the hinge rotation connector 30, and an upper portion pivots forward with respect to the hinge rotation connector 30 to open and close the cavity 101.

Depending on the specifications, the door 20 may be provided with a control panel (not shown) for cooking food within the cavity 101, and a wire harness (not shown) for electrical connection between the casing 10 and a control panel (not shown) provided on the door 20 may be routed to the hinge rotation connector 30.

However, the conventional cooking appliance 1 has a problem in that when the door 20 is opened to open the cavity 101, the complex hinge rotation connector 30 including the wire harness is directly exposed to a user, thereby detracting from the product's aesthetic appeal.

Furthermore, the conventional cooking appliance 1 has a problem in that, even when the door 20 is closed to close the cavity 101 for cooking, foreign substances such as oil from the food being cooked accumulate not only on the hinge rotation connector 30 but also on the wire harness, thereby requiring periodic cleaning.

In particular, when the cooking appliance 1 is a built-in type, the product cannot be moved during cleaning, which leads to the problem of longer cleaning time.

Furthermore, the case of Patent Document 1 (Patent Publication No. 1020210145971) also has a problem in that when the door is opened to open the cavity, the wire harness and the door hinge are exposed directly to a user, thereby detracting from the product's aesthetic appeal.

### SUMMARY

The disclosure has been made in view of the above problems, and may provide a cooking appliance capable of covering a hinge rotation connector and a wire harness when a door is opened and closed.

The disclosure may further provide a cooking appliance capable of cleaning so that foreign substances such as user’s oil can be easily removed.

The disclosure may further provide a cooking appliance capable of automatically covering a hinge rotation connector and a wire harness at all times in conjunction with the opening and closing of a door.

The objects of the present disclosure are not limited to the objects mentioned above, and other objects not mentioned will be clearly understood by those skilled in the art from the description below.

In accordance with an aspect of the present disclosure, a cooking appliance includes: a cavity which forms a cooking chamber therein; a casing which encloses at least a portion of the cavity; a door which is hinged to the casing by a hinge rotation connector to open and close the cavity; and a concealing cover which is withdrawn from a space between the cavity and the casing, and conceals the hinge rotation connector, when the door is opened.

In detail, the cooking appliance further includes a wire harness electrically connecting the door to the casing, in which the concealing cover has a concealing space that encloses the wire harness together with the hinge rotation connector.

The concealing cover moves by an elastic member provided inside the casing.

The concealing cover includes: a fixed cover which is fixed to the casing and has a hollow space opened forward and rearward; and a moving cover which moves to penetrate the fixed cover by expansion and restoring force of the elastic member.

The moving cover includes: a lower cover which defines a lower portion of the concealing space and is guided by a guidance of the fixed cover; and an upper cover which occupies an upper portion of the concealing space and is detachably coupled to the lower cover.

The upper cover is provided with various height specifications to change the vertical height of the concealed space, and the fixed cover is provided with various height specifications corresponding to the vertical height of the concealed space.

The moving cover is provided with a pair of guide ends integrally extending in the moving direction of the moving cover and having a first guide slot formed on the inside in a left-right direction, and the casing is provided with at least one case guide protrusion inserted into the first guide slot of the pair of guide ends.

A bottom surface of the lower cover is formed with a second guide slot that is long in the moving direction of the lower cover and is cut in the up-down direction, and the fixed cover is provided with a limit protrusion inserted into the second guide slot.

The moving cover is formed with an interference prevention groove that prevents interference with the hinge rotation connector.

The interference prevention groove is formed at a front end of the upper cover.

The door includes: a door frame; an outer door panel which is coupled to an inner side of the door frame, and forms an outer surface of the door; and an inner door panel which is coupled to the inner side of the door frame and spaced apart from the outer panel, and forms an inner surface of the door, in which the moving cover comes in contact with a fore-end(an end) of the hinge rotation connector which is positioned between the outer door panel and the inner door panel and arranged to guide a hinge rotation of the door, when the cavity is opened or closed by the door.

The interference prevention groove is in contact with the fore-end of the hinge rotation connector, when the cavity is opened or closed.

The elastic member has one end connected to the fixed cover and the other end connected to the moving cover, so that it expands when the moving cover is inserted and is restored when the moving cover is withdrawn.

The elastic member includes a spring.

The elastic member includes a torsion bar spring.

The moving cover has a front end which is in constant contact with the door and moves in conjunction with the door according to expansion and restoring force of the elastic member.

A lower portion of the casing further includes a height adjustment screw for adjusting a height with respect to a ground, and moving cover is formed so as not to interfere with the height adjustment screw when moving.

The concealing space of the moving cover includes: a first concealing space into which a fore-end of the hinge rotation connector is inserted; and a second concealing space in which the height adjustment screw is positioned.

In accordance with another aspect of the present disclosure, a cooking appliance includes: a cavity which forms a cooking chamber therein; a casing which encloses at least a portion of the cavity; a door which is hinged to the casing to open and close the cavity; and a concealing cover which is withdrawn from a space between the cavity and the casing when the door is opened, and is inserted into the space between the cavity and the casing when the door is closed.

In addition, the cooking appliance further includes a front panel covering the space between the casing and the cavity, and the concealing cover moves to penetrate a front opening formed in the front panel.

The front opening may be located between the lower end of the cavity and the lower end of the casing.

In accordance with another aspect of the present disclosure, a cooking appliance includes: a cavity which forms a cooking chamber therein; a casing which encloses at least a portion of the cavity; a door which is hinged to the casing by a hinge rotation connector to open and close the cavity; and a concealing cover which is positioned in a space between the casing and the cavity, and selectively conceals the hinge rotation connector as its length varies according to an operation of the door.

### BRIEF DESCRIPTION OF THE DRAWINGS

The above and other objects, features and advantages of the present disclosure will be more apparent from the following detailed description in conjunction with the accompanying drawings, in which:

FIG. 1 is a perspective view illustrating an example of a cooking appliance according to the prior art;

FIG. 2 is a front view of FIG. 1;

FIG. 3 is a perspective view illustrating a cooking appliance according to an embodiment of the present disclosure;

FIG. 4 is an exploded perspective view of the cooking appliance of FIG. 3;

FIG. 5 is a perspective view illustrating a concealing cover of a configuration of FIG. 3;

FIG. 6 is an exploded perspective view illustrating a moving cover of the concealing cover of FIG. 5;

FIG. 7 is a partial side perspective view taken along "B" direction of FIG. 3;

FIG. 8A and FIG. 8B are sectional views taken along line A-A in FIG. 3, showing the door in a closed state (A) and the door in an open state (B); and

FIG. 9A and FIG. 9B are cross-sectional views taken along the line C-C of FIG. 3, showing the door in a closed state (A) and the door in an open state (B).

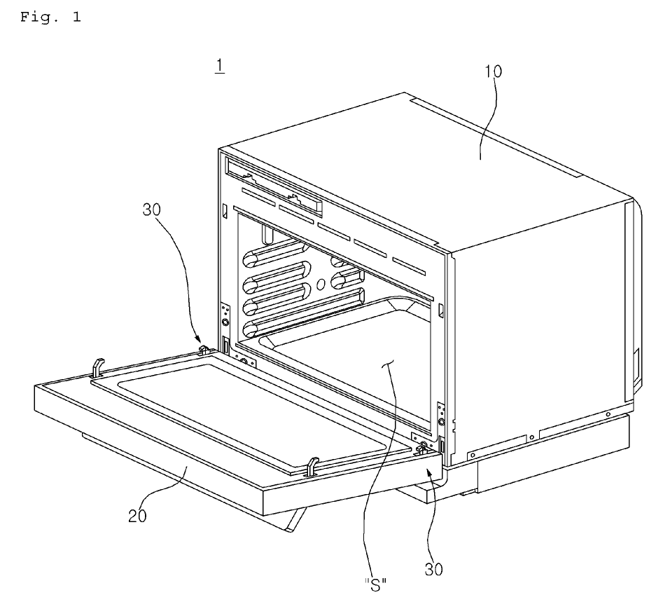

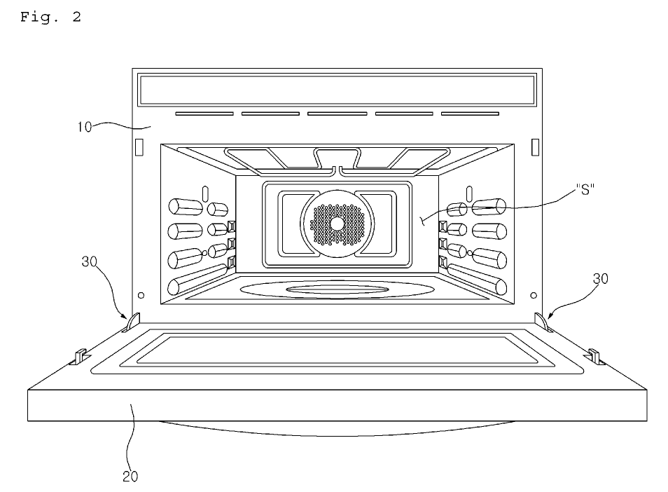

### DETAILED DESCRIPTION

Advantages and features of the present disclosure and methods of achieving them will become apparent with reference to the embodiments described below in detail in conjunction with the accompanying drawings. However, the present disclosure is not limited to the embodiments disclosed below, but may be implemented in various different forms, and these embodiments are provided only to allow the disclosure of the present disclosure to be complete, and to completely inform those of ordinary skill in the art to which the present disclosure belongs, the scope of the invention, and the present disclosure is only defined by the scope of the claims. Like reference numerals refer to like elements throughout.

Hereinafter, the present disclosure will be described with reference to drawings illustrating a cooking appliance 1 according to an embodiment of the present disclosure.

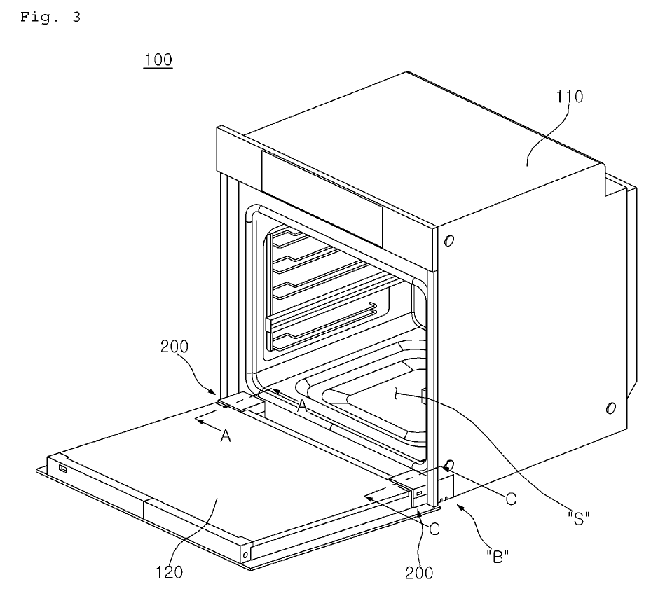

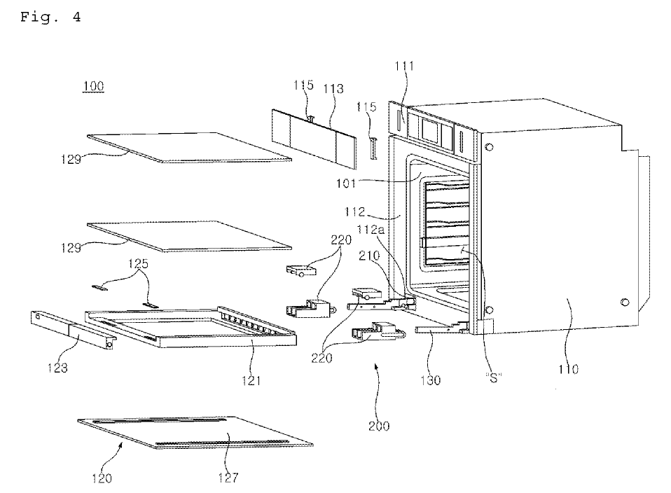

FIG. 3 is a perspective view illustrating a cooking appliance according to an embodiment of the present disclosure, and FIG. 4 is an exploded perspective view illustrating the cooking appliance of FIG. 3.

Referring to FIGS. 3 and 4, a cooking appliance 100 according to an embodiment of the present disclosure includes a casing 110 forming an outer shape. A cavity 101 for cooking food is provided inside the casing 110. The casing 10 may be formed to have an open front surface.

The cavity 101 forms a cooking chamber S in which a user can cook food. The cavity 101 approximately forms an hexahedral space, and may include a side surface forming left and right side surfaces of the cooking chamber S, an upper surface forming an upper surface, a bottom surface forming a lower surface, and a rear surface forming a back surface. A user may insert food for cooking into the cavity 101 through the open front surface of the casing 110.

The casing 110 forms a space, between the cavity 101, that accommodates a hinge rotation connector 130 and a concealing cover 200.

Specifically, the casing 110 includes a front panel 112 that covers at least the space between the casing 110 and the cavity 101. The front panel 112 may define a surface intersecting the front-rear direction.

The front panel 112 may have a surface extending from the front end of the cavity 101 to the outside of the cavity 101. The front panel 112 may be a surface connecting the front end of the cavity 101 and the front end of the casing 110.

Obviously, the front panel 112 may be a separate component or may be formed with the cavity 101 as one body.

The front panel 112 may include a front opening 112a that accommodates the concealing cover 200. The front openings 112a may be positioned on the left and right sides of the lower end of the front panel 112.

Furthermore, the front opening 112a may be positioned between the lower end of the cavity 101 and the lower end of the casing 110. The front opening 112a may be positioned adjacent to a corner of the cavity 101, at between the lower end of the cavity 101 and the lower end of the casing 110.

The front opening 112a provides a moving space, when the concealing cover 200 moves forward and rearward, and accommodates a portion of the hinge rotation connector 130. The front opening 112a may be formed by penetrating the front panel 112 in the front-rear direction. The front opening 112a may also be in the form of a notch.

The cooking appliance 100 according to an embodiment of the present disclosure may further include a door 120 that opens and closes the cavity 101 by rotating a hinge rotation connector 130 with respect to the casing 110. The door 120 closes the cavity 101 by covering the open front surface of the casing 110, and opens the cavity 101 by moving away from the front surface of the casing 110.

As illustrated in FIG. 4, the door 120 may be provided in combination of a door frame 121, at least one transparent panel 127, 129, and a door upper frame 123.

The door frame 121 may be formed in a square frame shape. When the cavity 101 is closed by the door 120, the door frame 121 may be drawn into the inside of the front end edge of the casing 110 and may be brought into close contact with a sealing member 190 of the casing 110. When the door frame 121 is brought into close contact with the sealing member 190, the front end surface may match the front end edge surface of the casing 110.

Here, at least one transparent panel 127, 129 may be installed on the door frame 121 to shield the opened inner side of the door frame 121. The at least one transparent panel 127, 129 may include an outer door panel 127 that is coupled to the front end side of the door frame 121 to form the front outer shape of the door 120, and an inner door panel 129 that is coupled to be spaced apart from the outer door panel 127. The inner door panel 129 may be provided as a pair spaced apart from each other in the front-rear direction.

The outer door panel 127 and the inner door panel 129 may be provided with a transparent or translucent material that allows a user to observe the cavity 101 corresponding to the inner cooking chamber from the outside. Preferably, if a lighting module (not shown) that illuminates the cooking chamber is provided, the outer door panel 127 and the inner door panel 129 may be provided with a special material that allows the cooking chamber to be observed from the outside only when light is illuminated by the lighting module. In particular, since one, among the pair of inner door panels 129, adjacent to the cavity 101 needs to be formed to withstand the high temperature and high pressure of the cooking chamber, and needs to have waterproofing and heat dissipation functions, this may be considered in the selection of materials.

The outer door panel 127 and the inner door panel 129 may be slidably inserted from the upper portion to the lower side of the door frame 121, when the door upper frame 123 provided on the upper portion of the door frame 121 is removed. After the outer door panel 127 and the inner door panel 129 are slidably inserted into the inner side of the door frame 121, the door upper frame 123 is coupled to the door frame 121.

The door 120 may further include a door handle (not shown) for easy opening and closing by a user. The door handle 21 may be formed on the front portion of the door upper frame 123. More preferably, the door handle 21 may be provided on the upper side of the outer door panel 127.

However, it is not necessary for the door 120 to be equipped with a door handle. For example, as shown in FIG. 4, the door 120 may further include a contact sensor 125 coupled to the rear surface of the door upper frame 123. When the closed state of the door 120 is detected by the contact sensor 125, the opening rotation of the cavity 101 in a one-touch manner may be performed according to the pressure applied by a user to the front surface of the door 120.

The door 120 serves to open and close the cavity 101 of the casing 110. To this end, a hinge installation part (not indicated in the drawing) on which a hinge rotation connector 130 described later is installed may be provided at the front lower portion of the casing 110. One hinge installation part may be formed at each of the left lower portion and the right lower portion of the front portion of the casing 110. The door 110 may open and close the cavity 101 in a pull-down manner in which the upper end pivots up and down around the lower end.

Meanwhile, a control panel 113 that displays the operating state of the cooking appliance 1 and controls its operation may be mounted at the front upper end portion of the casing 110. The control panel 113 may be provided as a touch panel. The control panel 113 may include an input unit that controls its operation by electrostatic touch input. The control panel 113 may be electrically connected through a pair of signal connection terminals 115 to receive an electrical signal from the casing 110.

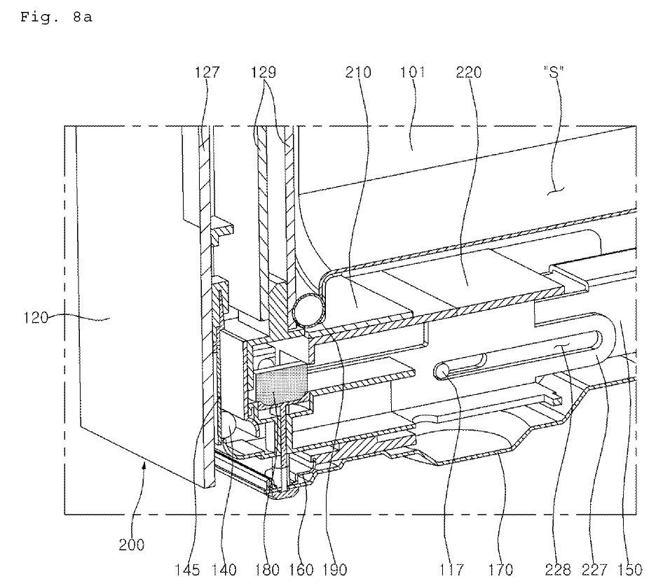

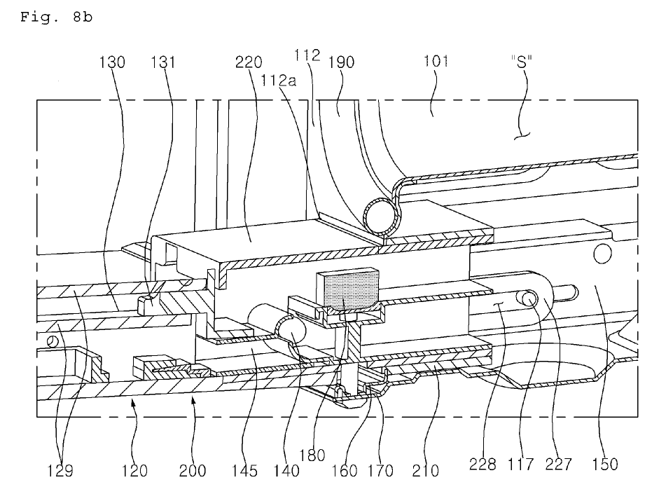

In addition, when the above-described lighting module is provided inside the door 120, the cooking appliance 1 according to an embodiment of the present disclosure may further include a wire harness (refer to reference numeral ‘140’ in FIGS. 8A and 8B described below) for supplying power to the lighting module. The wire harness 140 is configured to be covered so as not to be observed from the outside by a concealing cover 200 described below.

The cooking appliance 1 according to an embodiment of the present disclosure further includes a concealing cover 200 that is withdrawn from a space between the cavity 101 and the casing 110 when the door 120 is opened, and is drawn into the space between the cavity 101 and the casing 110 when the door 120 is closed.

The space between the cavity 101 and the casing 110 may include a side space between a side surface of the cavity 101 and a side surface of the casing 110, a lower space between a bottom surface of the cavity 101 and a bottom surface of the casing 110, an upper space between an upper surface of the cavity 101 and an upper surface of the casing 110, and a corner space between the lower space and the side space.

The concealing cover 200 is positioned in the space between the cavity 101 and the casing 110 when the door 120 is closed, and a portion of the concealing cover 200 is exposed to the outside of the space between the cavity 101 and the casing 110 when the door 120 is opened.

The concealing cover 200 is positioned between the cavity 101 and the casing 110 and, depending on the operation of the door 120, changes in length to selectively cover the hinge rotation connector. Depending on the operation of the door 120, a portion of the concealing cover 200 changes in length to selectively cover the hinge rotation connector.

When the door 120 is closed, a portion of the concealing cover 200 moves in the opposite direction of the door 120, and when the door 120 is opened, a portion of the concealing cover 200 moves toward the door 120. Specifically, the concealing cover 200 may be inserted into and removed from the lower space between the bottom surface of the cavity 101 and the bottom surface of the casing 110 and/or the corner space between the lower space and the side space. Preferably, the concealing cover 200 may be inserted into and removed from a position adjacent to the corner space in the lower space between the bottom surface of the cavity 101 and the bottom surface of the casing 110.

The concealing cover 200 may be moved through the front opening 112a of the front panel 112.

The concealing cover 200 is withdrawn from the inside of the casing 110 toward the door 120 when the door 120 is open, and is drawn toward the inside of the casing 110 from the outside of the casing 110 when the door 120 is closed, thereby permanently covering the hinge rotation connector 130.

In addition, the concealing cover 200 may cover a portion of the lower end of the door 120 when the door 120 is open. The concealing cover 200 may be positioned so as not to overlap with the door 120 in the up-down direction when the door 120 is closed. The concealing cover 200 is positioned so as to overlap with the door 120 in the horizontal direction when the door 120 is closed.

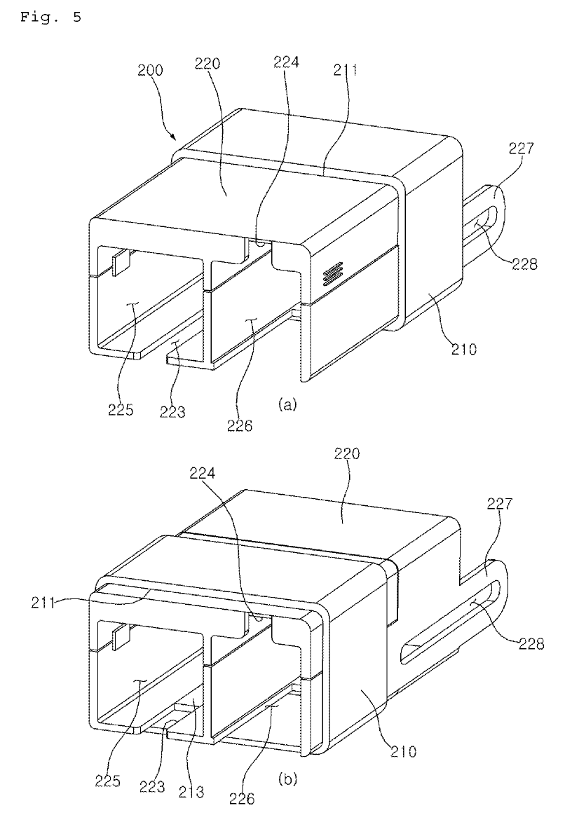

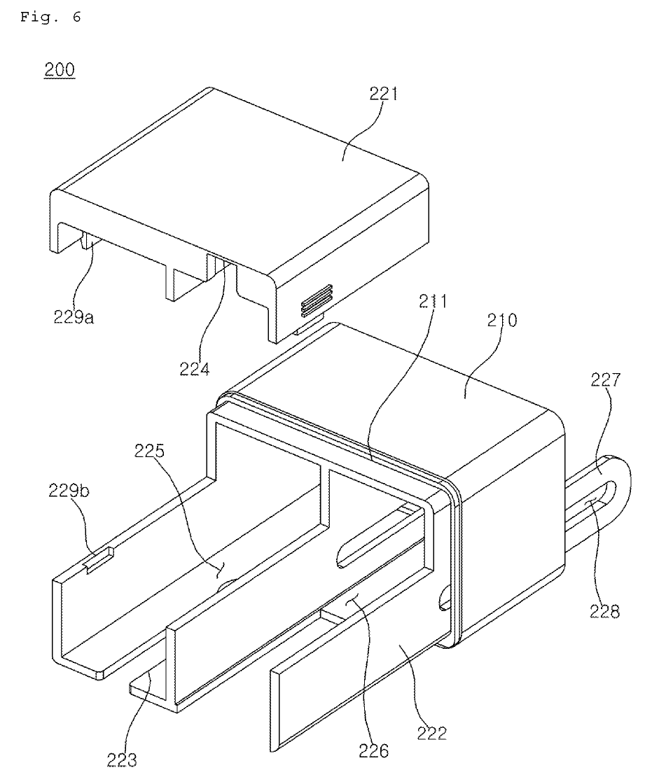

FIG. 5 is a perspective view illustrating a concealing cover of a configuration of FIG. 3, and FIG. 6 is an exploded perspective view illustrating a moving cover of the concealing cover of FIG. 5.

As referenced in FIGS. 5 and 6, the concealing cover 200 may include a fixed cover 210 that is fixed to the casing 110 and has a hollow space 211 that is opened forward and rearward, and a moving cover 220 that moves under the guidance of the fixed cover 210.

The fixed cover 210 is formed in a roughly square frame shape, and a hollow space 211 may be formed in a square shape inside the fixed cover 210. The hollow space 211 of the fixed cover 210 may be formed to be open in the front-rear direction. Here, the hollow space 211 of the fixed cover 210 may have a shape corresponding to the outer surface of a part of the moving cover 220 having the largest vertical cross-sectional area.

The fixed cover 210 may be fixed to the casing 110. The fixed cover 210 may be fixed to the lower end of the casing 110. Specifically, the fixed cover 210 may be fixed to a guide frame (refer to the reference numeral '150' in FIGS. 8A and 8B described below) provided at the lower portion of the front end of the casing 110. Such a fixed cover 210 serves to guide the moving cover 150 to slide to move in the front-rear direction through the hollow space 211 while being fixed to the guide frame 150.

In addition, the fixed cover 210 may be installed in the front opening 112a of the front panel 112.

As referred to in FIG. 5, the moving cover 220 may be formed with a concealing space 225, 226 to conceal the hinge rotation connector 130 and the wire harness 140 inside. The concealing space 225, 226 may be formed to be in communication with the moving cover 220 in the front-rear direction.

In addition, the moving cover 220 may be provided as a combination of a lower cover 222 and an upper cover 221. The lower cover 222 occupies the lower portion of the concealing space 225, 226 and, guided by the fixed cover 210 to substantially perform a sliding movement.

The upper cover 221 occupies the upper portion of the concealing space 225, 226, and may be detachably coupled to the lower cover 222. A plurality of hook protrusions 229a may be formed on the inner surface of the upper cover 221, and a plurality of hook coupling grooves 229b to which the plurality of hook protrusions 229a are hooked may be formed on the inner surface of the lower cover 221.

Here, the upper cover 221 may be provided with various height specifications in order to change the vertical height of the concealing space 225, 226. For example, since the volume occupied by the hinge rotation connector 130 and wire harness 140 (or height adjustment screw 180 described later) that are concealed and arranged inside the concealing space 225, 226 is different for each product, the upper cover 221 may be replaced and installed on the lower cover 222 to correspond to the vertical height of various concealing spaces 225, 226. However, since the moving cover 220 is configured to be guided by penetrating the hollow space 211 of the fixed cover 210, it is preferable to be provided with various height specifications corresponding to the vertical height of the concealing space 225, 226 changed by replacing the upper cover 221.

A pair of guide ends 227 may be formed as one body in the moving cover 220. More specifically, the pair of guide ends 227 may be formed at the rear end of the lower cover 222 of the moving cover 220. The pair of guide ends 227 may be formed to extend from the rear end of the moving cover 220 in the moving direction of the moving cover 220. That is, the pair of guide ends 227 may be formed to be long in the front-rear direction at the rear end of the moving cover 220. A first guide slot 228 cut in the left-right direction may be formed on the inner side of the pair of guide ends 227. The pair of guide ends 227 may be arranged to be spaced apart from each other by a certain interval in the left-right direction at the rear end of the moving cover 220.

A second guide slot 223 may be formed in the moving cover 220. More specifically, the second guide slot 223 may be formed on the inner bottom surface of the lower cover 222 of the moving cover 220. The second guide slot 223 may be formed by a cut-out in the bottom surface of the lower cover 222, and may be formed long in the moving direction (i.e., the front-rear direction) of the lower cover 222, but may be formed by cutting in the up-down direction. The second guide slot 223 may be formed by cutting a certain distance from the front end of the inner bottom surface of the lower cover 222 to the rear.

Meanwhile, a limit protrusion (not shown) inserted into the inside of the second guide slot 223 may be formed in the fixed cover 210. The limit protrusion is inserted into the inside of the second guide slot 223, thereby performing the function of preventing the forward removal of the moving cover 220 by engaging with the rear end of the second guide slot 223 when the lower cover 222 slides forward.

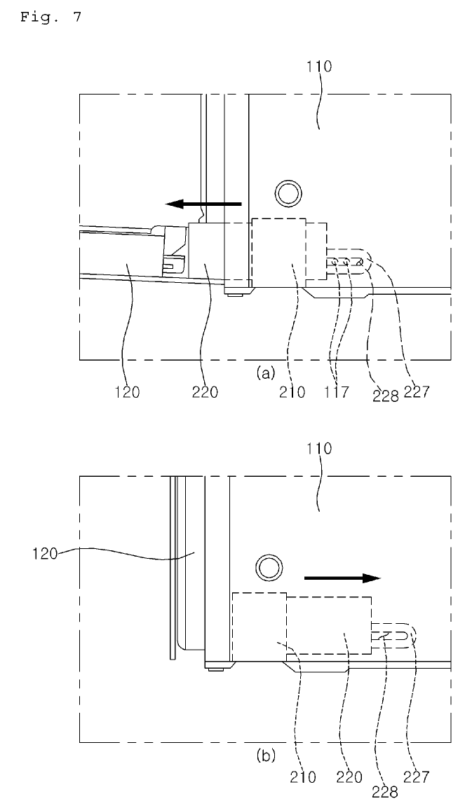

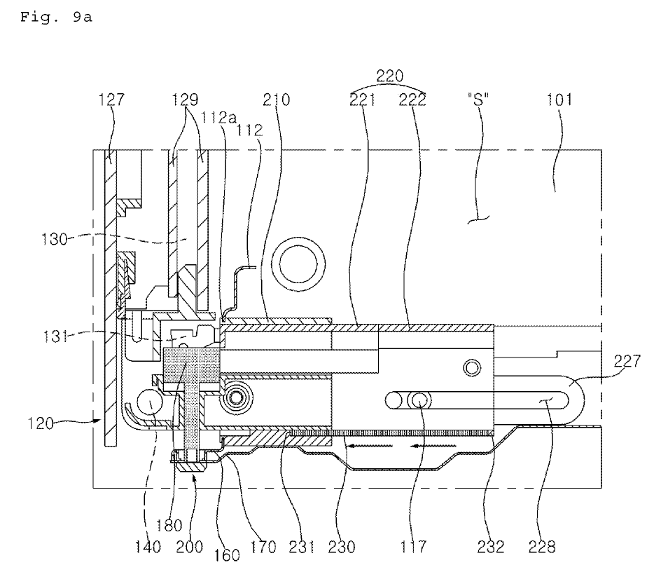

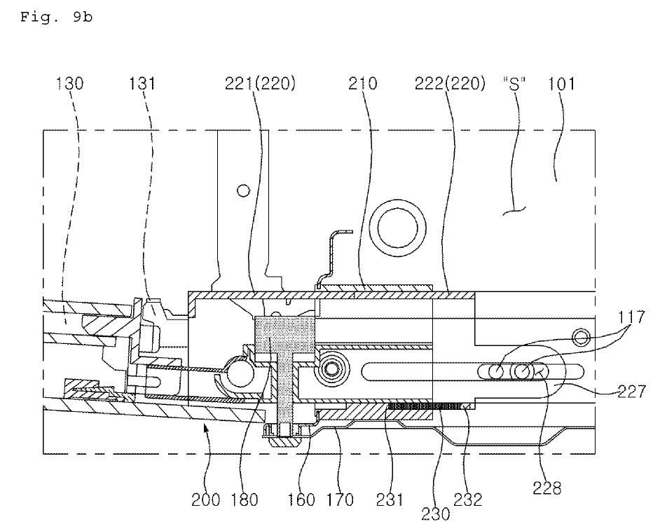

FIG. 7 is a partial side perspective view taken along "B" direction of FIG. 3, FIG. 8A and FIG. 8B are sectional views taken along line A-A in FIG. 3, showing the door in a closed state (A) and the door in an open state (B), and FIG. 9A and FIG. 9B are cross-sectional views taken along the line C-C of FIG. 3, showing the door in a closed state (A) and the door in an open state (B).

In the cooking appliance 1 according to an embodiment of the present disclosure, as referenced in FIGS. 8A to 9B, the hinge rotation connector 130 for a pull-down type pivot opening and closing with respect to the casing 110 may be connected to the door 120.

The hinge rotation connector 130 may be arranged in a space between the outer door panel 127 and the inner door panel 129 of the door 120. A fore-end 131 of the hinge rotation connector 130 may be partially exposed to the lower portions of the outer door panel 127 and the inner door panel 129 and may be hinge-connected to the casing 110. Preferably, the front end of the hinge rotation connector 130 may be hinge-connected to the front end side of the guide frame 150 that is provided long in the front-rear directions on both left and right sides of the lower portion of the front end of the casing 110.

Here, the fore-end 131 of the hinge rotation connector 130 may be concealed from the outside by being located in the concealing space 225, 226 of the moving cover 220 that is withdrawn forward when the door 120 is opened. The fore-end 131 of the hinge rotation connector 130 may be a part that is always in contact with the moving cover 220 when the door 120 is opened or closed.

Such a hinge rotation connector 130 may be provided at both left and right ends of the door 120. That is, an installation part for hinge-connecting the fore-end 131 of the hinge rotation connector 130 may be provided at the lower portions of the left and right ends of the front end of the casing 110, and guide frames 150 may be respectively arranged in the front and rear directions at the installation part.

Meanwhile, the cooking appliance 1 according to an embodiment of the present disclosure may further include a height adjustment screw 180 provided at the lower end of the casing 110, as referenced in FIGS. 8A to 9B. The height adjustment screw 180 may be provided at the lower side of the front end of the casing 110. More specifically, the height adjustment screw 180 may be installed to penetrate the lower front end of the casing 110 where the inner case panel 160 provided relatively inside the casing 110 and the outer case panel 170 forming the outer shape of the casing 110 are coupled.

The height adjustment screw 180 is provided with a knob not indicated in the drawing for height adjustment at the top, and the knob of the height adjustment screw 180 may be positioned in the concealing space 225, 226 of the moving cover 220 described above and concealed from the outside.

Here, as shown in FIGS. 5 and 6, the concealing cover 225, 226 formed on the moving cover 220 may be divided into a first concealing space 225 where the knob portion of the height adjustment screw 180 described above is located, and a second concealing space 226 where the fore-end 131 of the hinge rotation connector 130 described above is located.

As described above, a second guide slot 223 is formed on the bottom surface of the lower cover 222 corresponding to the first concealing space 225, so that the height adjustment screw 180 fixed to the casing 110 does not interfere with the forward-rearward sliding movement of the lower cover 222.

In addition, the bottom surface of the lower cover 222 corresponding to the second concealing space 226 may be partially cut so as not to interfere with the rotation of the hinge rotation connector 130, and an interference prevention groove 224 having a rounded vertical cross-section may be formed on the upper portion of the upper cover 221 corresponding to the second concealing space 226 so as to prevent the moving cover 220 from being lifted at the fore-end 131 of the hinge rotation connector 130. The interference prevention groove 224 may be formed with a round surface to the extent that the moving cover 220 that comes into contact with it is not lifted upwards, in consideration of the rotation trajectory of the fore-end 131 of the hinge rotation connector 130.

However, the prevention of the lifting phenomenon of the moving cover 220 due to the rotational motion of the fore-end 131 of the hinge rotation connector 130 is not necessarily achieved only by the interference prevention groove 224 of the moving cover 220. For example, the fore-end 131 of the hinge rotation connector 130 may also be designed to make contact with the moving cover 220 without interference.

The interference prevention groove 224 may be formed by recessing the upper cover 221. The interference prevention groove 224 may be a groove that is open to the second concealing space 226. The interference prevention groove 224 may be a groove that is open in a downward direction.

Meanwhile, as shown in FIGS. 8A to 9B, the cooking appliance 1 according to an embodiment of the present disclosure may include a guide frame 150 disposed on the lower side of the front end of the casing 110 to guide the forward and rearward sliding movement of the moving cover 220.

The fixed cover 210 may be fixed to the guide frame 150, and the fore-end 131 of the hinge rotation connector 130 may be hinge-coupled to a fore-end that is further forward of the fixed cover 210. In addition, a case guide protrusion 117 inserted into the first guide slot 128 described above may be provided at the rear end of the guide frame 150.

The case guide protrusion 117 is inserted and positioned inside the first guide slot 128, thereby guiding the forward and rearward sliding movement of the moving cover 220, and also serving to restrict the forward and rearward sliding movement range of the moving cover 220 within the range of the front-rear length direction of the first guide slot 128.

Meanwhile, in the cooking appliance 1 according to an embodiment of the present disclosure, the moving cover 220 slides to move in the front-rear direction with respect to the fixed cover 210, and may move by the expansion and restoring force of the elastic member 230.

The elastic member 230 may be provided inside the lower portion of the front end of the casing 110, as shown in FIGS. 9A and 9B. Here, the elastic member 230 may be provided as a spring. The elastic member 230 provided as a spring may have one end 231 connected to the fixed cover 210 and the other end 232 connected to the moving cover 220.

Such an elastic member 230 may be expanded by the moving cover 220 that slides rearward and is inserted into the casing 110 by contact with the fore-end 131 of the hinge rotation connector 130 when the cavity 101 of the door 120 is closed.

Conversely, the elastic member 230 may slide forward and move the moving cover 220 so as to be withdrawn from the casing 110 while forming a restoring force that is expanded and then contracted when the cavity 101 of the door 120 is opened. That is, the moving cover 220 may move in conjunction with the door 120 according to the expansion and restoring force of the elastic member 230 as its front end constantly comes in contact with the fore-end 131 of the hinge rotation connector 130 of the door 120.

However, the elastic member 230 does not necessarily have to be provided as a spring, and although not shown, it may be provided as a torsion bar spring. The elastic member 230 provided as a torsion bar spring may be provided so that one end is connected to the fixed body 210 or guide frame 150 in a fixed state, and the other end is connected to the moving cover 220, thereby forming the above-described expansion and restoring force.

As described above, the cooking appliance 1 according to an embodiment of the present disclosure is provided so that it may be automatically withdrawn from and inserted into the casing 110 in conjunction with the opening and closing rotation of the door 120 according to the expansion and restoring force of the elastic member 230 without having a separate power source for the sliding movement of the moving cover 220, thereby simplifying the internal design.

Meanwhile, a sealing member 190 may be further provided at a portion with which the front surface of the door frame 121 of the door 120 is in close contact, among the front end of the casing 110. The sealing member 190 may be made of a flexible material, such as rubber or silicone, and may serve to seal the cavity 101, which is the cooking chamber, when pressed by the door frame 121 or the door upper frame 123.

Hereinafter, the operation of the cooking appliance 1 according to an embodiment of the present disclosure configured as described above will be described. First, as referenced in FIG. 9A, during the closing rotation of cavity 101 by using the door 120, the fore-end 131 of the hinge rotation connector 130 linked to the door 120 comes into contact with the moving cover 220 and moves it rearward. At this time, the moving cover 220 may be naturally slid and moved into the inside of the casing 110 while being prevented from being lifted upwards by the guidance of the guide frame 150 together with the guidance of the fixed cover 210. In addition, the elastic member 230 expands as the moving cover 220 moves into the inside of the casing 110, and continuously provides elastic force forward.

Next, as referenced in FIG. 9B, during the opening rotation of cavity 101 by using the door 120, in a state of being stopped inside the casing 110 by the hinge rotation connector 130 of the door 120, the moving cover 220 is withdrawn forward from the inside of the casing 110 by the restoring force of the elastic member 230, and may accommodate the fore-end 131 of the hinge rotation connector 130, and the knob portion of the wire harness 140 and the height adjustment screw 180 into the concealing space 225, 226 to conceal from the outside.

As described above, the cooking appliance 1 according to an embodiment of the present disclosure prevents deterioration of the product's appearance by concealing components such as the hinge rotation connector 130, the wire harness 140, and the height adjustment screw 180 from the outside, by using the moving cover 220 when the door 120 is open.

Furthermore, even when the door 120 is closed, foreign substances such as oil from the cooking (food) in the cooking chamber are induced to accumulate only on the outer surface of the moving cover 220, thereby improving user convenience in cleaning.

The cooking appliance of the present disclosure has one or more of the following effects.

The present disclosure has the advantage of preventing deterioration of the product's appearance when the door is opened by concealing the area where the hinge rotation connector and the wire harness are installed by using the concealing cover.

Furthermore, the present disclosure has the advantage of preventing the accumulation of foreign substances, such as oil, generated from food being cooked in the cooking space, by always covering the hinge rotation connector and the wire harness through the concealing cover.

Furthermore, the present disclosure has the advantage of enhancing user convenience by performing cleaning by removing only a portion of the removable moving cover among the concealing cover.

Furthermore, the present disclosure has the design advantage of allowing simple installation of the concealing cover without a separate driving source by moving the concealing cover in conjunction with the opening and closing of the door by using an elastic member.

The effects of the present disclosure are not limited to those mentioned above, and other unmentioned effects will be clearly understood by those skilled in the art from the description of the claims.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

The present disclosure may be implemented in various forms and modifications, and the scope of the present disclosure is not limited to the embodiments described above. Therefore, if a modified embodiment includes elements of the claims of the present disclosure, it should be considered to fall within the scope of the present disclosure.

Certain embodiments or other embodiments of the disclosure described above are not mutually exclusive or distinct from each other. Any or all elements of the embodiments of the disclosure described above may be combined or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cooking appliance comprising:
a cavity forming a cooking chamber therein;
a casing enclosing at least a portion of the cavity;
a door hinged to the casing by a hinge rotation connector to open and close the cavity; and
a concealing cover withdrawn from a space between the cavity and the casing, and conceals the hinge rotation connector, when the door is opened.

2. The cooking appliance of claim 1, further comprising a wire harness electrically connecting the door to the casing,
wherein the concealing cover includes a concealing space that encloses the wire harness together with the hinge rotation connector.

3. The cooking appliance of claim 1, wherein the concealing cover is moved by an elastic member provided inside the casing.

4. The cooking appliance of claim 3, wherein the concealing cover comprises:
a fixed cover which is fixed to the casing and has a hollow space opened forward and rearward; and
a moving cover which moves to penetrate the fixed cover by expansion and restoring force of the elastic member.

5. The cooking appliance of claim 4, wherein the moving cover comprises:
a lower cover which defines a lower portion of the concealing space and is guided by a guidance of the fixed cover; and
an upper cover which occupies an upper portion of the concealing space and is detachably coupled to the lower cover.

6. The cooking appliance of claim 4, wherein the moving cover is formed with at least one first guide slot extending in a moving direction of the moving cover,
wherein the casing is provided with at least one case guide protrusion that is inserted into the first guide slot.

7. The cooking appliance of claim 5, wherein a bottom surface of the lower cover is formed with a second guide slot extending in a moving direction of the lower cover,
wherein the fixed cover is provided with a limit protrusion inserted into the second guide slot.

8. The cooking appliance of claim 5, wherein the moving cover is formed with an interference prevention groove that prevents interference with the hinge rotation connector.

9. The cooking appliance of claim 8, wherein the interference prevention groove is formed at a front end of the upper cover.

10. The cooking appliance of claim 9, wherein the door comprises:
a door frame;
an outer door panel which is coupled to an inner side of the door frame, and forms an outer surface of the door; and
an inner door panel which is coupled to the inner side of the door frame and spaced apart from the outer panel, and forms an inner surface of the door,
wherein the moving cover comes in contact with one end of the hinge rotation connector which is positioned between the outer door panel and the inner door panel and arranged to guide a hinge rotation of the door, when the cavity is opened or closed by the door.

11. The cooking appliance of claim 10, wherein the interference prevention groove is in contact with the one end of the hinge rotation connector, when the cavity is opened or closed.

12. The cooking appliance of claim 5, wherein the elastic member has one end connected to the fixed cover and the other end connected to the moving cover.

13. The cooking appliance of claim 12, wherein the elastic member comprises a spring.

14. The cooking appliance of claim 12, wherein the elastic member comprises a torsion bar spring.

15. The cooking appliance of claim 12, wherein the moving cover has a front end which is in constant contact with the door and moves in conjunction with the door according to expansion and restoring force of the elastic member.

16. The cooking appliance of claim 10, wherein a lower portion of the casing further comprises a height adjustment screw for adjusting a height with respect to a ground,
wherein the moving cover is formed so as not to interfere with the height adjustment screw when moving.

17. The cooking appliance of claim 16, wherein the concealing space of the moving cover comprises:
a first concealing space into which an end of the hinge rotation connector is inserted; and
a second concealing space in which the height adjustment screw is positioned.

18. A cooking appliance comprising:
a cavity forming a cooking chamber therein;
a casing enclosing at least a portion of the cavity;
a door hinged to the casing to open and close the cavity; and
a concealing cover which is withdrawn from a space between the cavity and the casing, and conceals a portion of the door when the door is opened, and is inserted into the space between the cavity and the casing when the door is closed.

19. The cooking appliance of claim 18, further comprising a front panel covering the space between the casing and the cavity,
wherein the concealing cover moves to penetrate a front opening formed in the front panel.

20. A cooking appliance comprising:
a cavity forming a cooking chamber therein;
a casing enclosing at least a portion of the cavity;
a door hinged to the casing by a hinge rotation connector to open and close the cavity; and
a concealing cover which is positioned in a space between the casing and the cavity, and selectively conceals the hinge rotation connector as its length varies according to an operation of the door.
